(19) United States
(12) Patent Application Publication
(10) Pub. No.: US 2021/0065229 A1
(43) Pub. Date: Mar. 4, 2021

(54) SYSTEM AND METHOD TO DETECT CHANGES IN ELECTRONIC PAYMENT ACCOUNTS

(71) Applicant: VISA INTERNATIONAL SERVICE ASSOCIATION, San Francisco, CA (US)

(72) Inventors: Amoul Singhi, Foster City, CA (US); Wan Jiang, Foster City, CA (US); Lingchen Guo, Foster City, CA (US)

(21) Appl. No.: 16/550,785

(22) Filed: Aug. 26, 2019

(51) Int. Cl. G06Q 30/02; G06Q 10/06

(52) U.S. Cl. CPC G06Q 30/0224; G06Q 10/0635; G06Q 30/0215

(57) ABSTRACT

The system and method may determine a subset of electronic account holders where the subset previously used an electronic account to make a purchase in predetermined categories. The purchase habits of the subset may be analyzed by reviewing the past purchase of the subset during a time period, determining reduced members of the subset wherein reduced members comprise members which reduce usage of the electronic payment account during the time period and determining parameters of the reduced members. A flight risk may be determined for the electronic payment users by analyzing the subset for members that comprise the parameters, determining a flight risk score by scoring the parameters and identifying flight risk members wherein flight risk members include members scored over a threshold. In response, an electronic offer may be communicated to the flight risk members.

### BACKGROUND

Account issuers such as credit card issuers offer services to users or entities in exchange for various benefits/rewards. Services may include check clearing services or credit services among many possible services. These rewards may change and vary as the account issuer attempts to target different individuals or entities. However, the rewards may create an incentive for the users or entities to switch accounts in the pursuit of new, better or different forms of rewards. Losing account users, especially desirable account users, can have negative effects on the account issuers.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A method and system of determining changes in electronic payment accounts may be disclosed. The method and system may be physically created to attempt to determine desirable account users that are likely to stop using an account and try to create an offer that will entice the users to continue using the account. The system and method may determine a subset of electronic account holders where the subset previously used an electronic account to make a purchase in predetermined categories. The purchase habits of the subset may be analyzed by reviewing the past purchase of the subset during a time period, determining reduced members of the subset wherein reduced members comprise members which reduce usage of the electronic payment account during the time period and determining parameters of the reduced members. A flight risk may be determined for the electronic payment users by analyzing the subset for members that comprise the parameters, determining a flight risk score by scoring the parameters and identifying flight risk members wherein flight risk members include members scored over a threshold. In response, an electronic offer may be communicated to the flight risk members.

### BRIEF DESCRIPTION OF THE FIGURES

FIG. 1 may be an illustration of a generic payment system;

FIG. 2 may be an illustration of method in accordance with the claims

FIG. 3 may be an illustration of a data set used by machine learning;

FIG. 4a may be an illustration of a data set being rotated and a different portion being used as a verification set;

FIG. 4b may be an illustration of a data set being rotated and a different portion being used as a verification set; and

FIG. 5 may be an illustration of a computing system.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SPECIFICATION

The present disclosure now will be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is an exemplification and is not intended to be limited to any one of the embodiments illustrated. The disclosure may be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

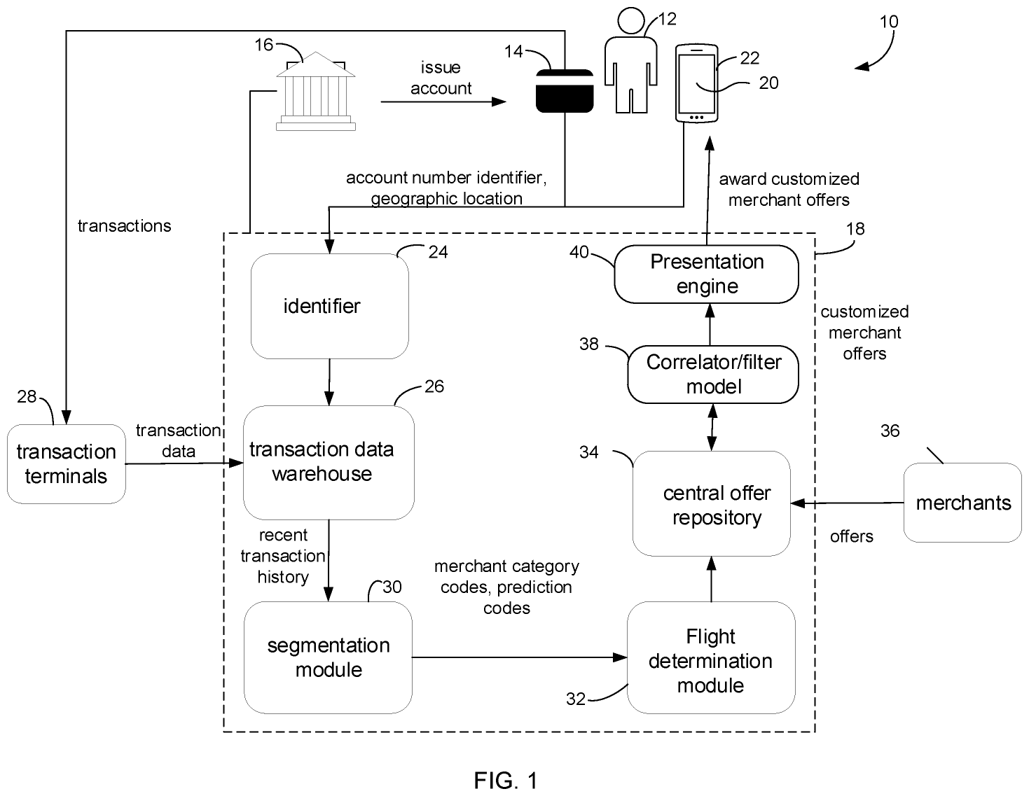

Referring now to the drawings and with specific reference to FIG. 1, a system 10 for determining that a consumer 12 is a flight risk is disclosed. The consumer 12 may hold one or more accounts 14 such as, but not limited to, a credit card account, a debit account, a prepaid account, a bank account, and a stored value account. An issuer 16 may issue the one or more accounts 14 to the consumer 12, and may provide the consumer 12 with a customized offer system 18 that presents customized offers to the consumer 12 which are specifically tailored to the consumer's spending behavior. The offers may be for a limited time in an effort to entice a user to change accounts for a longer period of time than the offer as the offers may be costly. The customized offers may be provided at a display interface 20 of a device 22 of the consumer 12. As non-limiting examples, the device 22 may be a smartphone, a tablet, or a personal computer. In one embodiment, the customized offer system 18 is an application program that is downloaded onto the consumer's device 22.

The flight risk determination system 18 may include an identifier 24 to identify the consumer 12. To identify the consumer 12, the identifier 24 may receive one or more account number identifiers associated with the consumer's account(s) 14 as input. Additionally, the identifier 24 may receive additional information such as the consumer's current geographic location (latitude and longitude coordinates) as input if such information is available via the consumer's device 22. The system 18 may further include a transaction data warehouse 26 that stores records of purchases or transactions made by the consumer 12 with the account 14 at merchant transaction terminals 28, as well as records of purchases made by other consumers with accounts issued by the issuer 16. The transaction data warehouse 26 may use the consumer's account number identifier to locate transaction data files specific to the consumer 12 and create data files of the consumer's transaction history. The consumer's transaction history may be continuously updated in the transaction data warehouse 26 as the consumer 12 makes purchases with the account 14.

The system 18 may further include a segmentation module 30 configured to extract the consumer's recent transaction history from the transaction data warehouse 26. The consumer's recent transaction history may include details of each of the purchases made by the consumer 12 with the account(s) 14 over a defined time period that may be a period of days, weeks, or months, for example.

As explained in further detail below, the segmentation module 30 may be configured to apply computational segmentation scoring to identify a group of leading merchant category codes based on the consumer's recent transaction history and current geographic location, if available. To identify the group of leading merchant category codes, the segmentation module 30 may identify a group of leading merchants in the consumer's recent transaction history, and associate each of the leading merchants in the group with a corresponding merchant category. For example, the group of leading merchants may be a group of merchants in the consumer's recent transaction history that the consumer 12 spent the most amount of money at and/or most frequently patronized. The merchant category codes may classify the leading merchants according to variables such as, but not limited to, type of retail, type of service, geographic location, and combinations thereof. In addition to identifying the group of leading merchant category codes, the segmentation module 30 may be further configured to apply computational segmentation scoring to provide prediction codes that predict the consumer's future spending behavior. Specifically, the prediction codes may be merchant category codes that will likely populate the consumer's future spending profile and likelihood of an account becoming dormant.

Referring still to FIG. 1, the segmentation module 30 may output the identified group of leading merchant category codes and/or prediction codes to a correlator/filter module 38. The correlator/filter module 38 may be in communication with a central offer repository 34 that holds current merchant offers provided by various merchants 36. Each of the offers stored in the central offer repository 34 may be tagged with one or more merchant category codes that may or may not correspond with the merchant category codes/prediction codes identified by the segmentation module 30.

The flight determination module 32 may determine the flight risk of a consumer. As will be described, the flight risk may be determined in a variety of ways. In addition, the flight risk module 32 may use the central office repository 34, correlator model 38 and presentation engine 40 to present offers to consumers to entice the desirable users to stay.

The correlator/filter module 38 may be configured to filter the offers in the repository 34 according to the group of leading merchant category codes, the prediction codes, and/or the consumer's current geographic location to provide offers that are customized to the consumer 12. Specifically, the correlator/filter module 38 may match the group of leading merchant category codes and prediction codes with corresponding offers stored in the central offer repository 34 to provide the customized offers if the consumer is viewed as a flight risk.

The correlator/filter module 38 may output the customized offers to a presentation engine 40 that is configured to present the customized offers to the consumer 12 at the display interface 20. To increase the consumer's engagement and incentivize the consumer to view the offers, each of the customized offers may be presented to the consumer 12 as a mystery offer or as an award in an interactive game. In one embodiment, the customized merchant offers may be transmitted to the consumer 12 via the application downloaded on the consumer's device 22. In other embodiments, the customized offers may be transmitted to the consumer 12 by text, email, dynamic email, or postal mail. In some embodiments, the account may use an app on a portable computing device and the app may display the offers. The customized offers may be downloaded, printed, or used directly by the consumer 12 for future purchases.

The above-described system 18 provides benefits to the issuer 16, the consumer 12, and the merchants 36. By identifying desirable customers that are likely to switch accounts and, in response, communicating personalized offers to these customers, the issuer 16 may benefit by increasing customer interest, loyalty and a continued revenue base assuming the consumer does not stop using the account. The account issuer 16 may also benefit by receiving revenue for use of the customized offer system 18, as well as increases in account transaction volumes as the consumer applies the customized merchant offers in future purchases. In addition, the consumer 12 may benefit by receiving current merchant offers that are more meaningful and tailored to his or her interests and spending styles. Furthermore, the consumer 12 may enjoy the benefits of purchasing desired items at a discount or with an added gift. The merchants 36 may benefit as the customized offer system 18 matches and targets their current offers to the consumers that are more likely to apply the offers in future transactions. This may translate into increased merchant sales and profits. In other words, by applying a technical solution to the problem of flight risk, the field of determining and addressing flight risk may be fundamentally changed for the better.

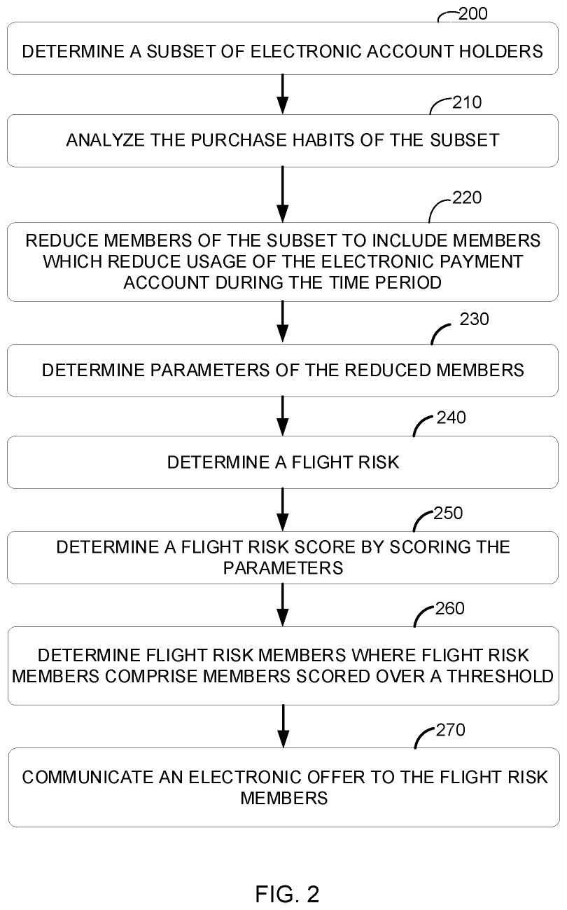

Referring to FIG. 2, a method of determining changes in electronic payment accounts for the purpose of identifying accounts which may go dormant may be illustrated. At block 200, a subset of electronic account holders may be determined where the subset may have used an electronic account to make a purchase in predetermined categories.

Electronic accounts may take on many forms and the accounts continue to evolve. Savings accounts may track money and allow withdrawals from ATM. Checking accounts allow drafts to be created and circulated to pay bills. Credit accounts allow transactions to occur, be reviewed for fraud and be accumulated for payment at one time or over a period of time. In addition, electronic accounts may track a variety of stores of value such as airline reward points, merchant reward points, bitcoins, electronic tokens, and the like. The system and method may be applicable to all electronic accounts.

As mentioned briefly, predetermined categories may be determined by reviewing past electronic purchases of electronic account holders and selecting account holders that changed their behavior in measurable ways such as decreasing or stopping usage of an account. In some embodiments, predetermined categories may be used. For example, an account issuer may have great confidence that a drop in spending month over month over a certain percentage may be a good enough indicator that the account should be reviewed more closely. Thus, a category may be made up of account holders that have a month to month spending change over a certain percentage, especially when an initial offer period has ended.

In one example, categories may be merchant codes for purchase transactions. In another example, categories may be more detailed such as purchases of product categories which may be helpful when a purchase is made from a superstore which may sell products (and services) in hundreds of product categories.

Categories also may relate not just to the product or service purchased but also may relate to the amount of the purchase. For example, purchases for small amounts may not result in large rewards or large compensation for the account issuers while purchases for large amounts may have more meaning to some account issuers. Other possible categories may include:

a location of where a purchase was made;

whether a purchase was a routine purchase or a novel purchase;

whether the purchases could be classified as routine amounts or as different amounts; and

whether purchases where at a different merchants as opposed to merchants used by the consumer in the past.

Machine learning may be also be used to determine categories which may provide the greatest meaning to an account issuer. By reviewing the data, categories may be determined of users that may benefit from additional study and review. The machine learning may be able to assist in creating useful categories and eliminating un-useful categories.

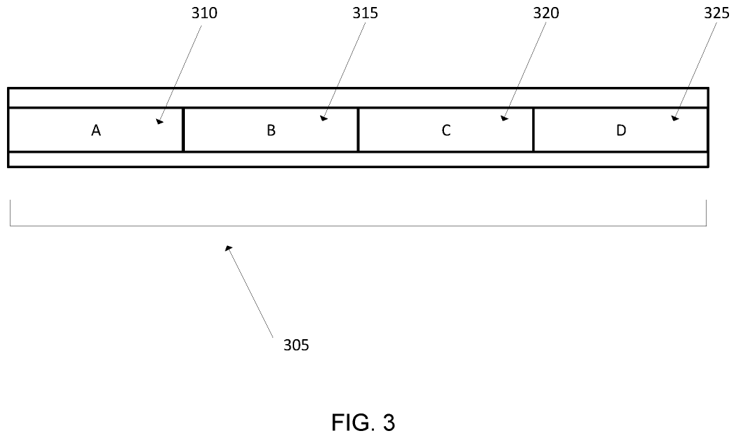

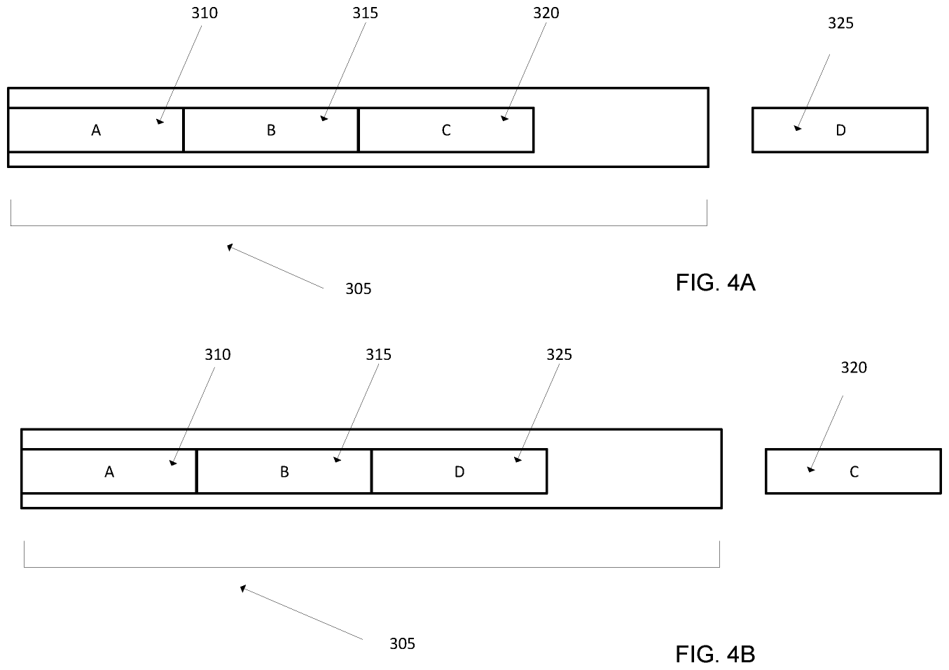

At a high level, machine learning may be used to review a training group of past weighting data and determine weighting moving forward. FIG. 3 may illustrate sample artificial intelligence (AI) training data according to one or more embodiments. As an example and not a limitation, an artificial intelligence system may trained by analyzing a set of training data 305. The training data may be broken into sets, such as set A 310, set B 315, set C 320 and set D 325. As illustrated in FIG. 4a, one set may be using as a testing set (say set D 325) and the remaining sets may be used as training set (set A 310, set B 315 and set C 320). The artificial intelligence system may analyze the training set (set A 310, set B 315 and set C 320) and use the testing set (set D 325) to test the model create from the training data. Then the data sets may shift as illustrated in FIG. 4b, where the test data set may be added to the training data sets (say set A 310, set B 315 and set D 325) and one of the training data sets that have not been used to test before (say set C 320) may be used as the test data set. The analysis of the training data (set A 310, set B 315 and set D 325) may occur again with the new testing set (set C 320) being used to test the model and the model may be refined. The rotation of data sets may occur repeatedly until all the data sets have been used as the test data sets. The model then may be considered complete and the model may then be used on additional data sets.

At block 210, the purchase habits of the subset may be analyzed. The analysis may occur in a variety of ways. At a minimum, the past purchase of the subset during a time period may be reviewed during a past time period. The analysis may include reviewing past electronic purchases using an algorithm to identify parameters. At a high level, machine learning may be used to review a training group of past weighting data and determine weighting moving forward described in FIGS. 3, 4a and 4b. A plurality of algorithms may be tested and the algorithm that performs the best may be selected. Some examples of machine learning algorithms may include Linear Regression, Logistic Regression, Decision Tree, SVM (support vector machine), Naive Bayes, kNN (k-nearest neighbors), K-Means, Random Forest, Dimensionality Reduction Algorithms and Gradient Boosting algorithms. The algorithms may be further adjusted to determine best most appropriate algorithm.

At block 220, members of the subset may be reduced to include members which reduce usage of the electronic payment account during the time period. The time period may be a default such as six months. In other embodiments, the time period may be shorter or may be longer. In some embodiments, the time period may relate to the time period of the promotion an account may be offering. For example, if an account offers double points for three months, the system and method may study six months as the user may be unlikely to leave in the first three months but may be likely to leave after the promotion period of three months ends. In some embodiments, the most useful time period may be determined using machine learning to review past time periods and determining which time period may be most useful. At a high level, machine learning may be used to review a training group of past weighting data and determine weighting moving forward described in FIGS. 3, 4a and 4b to determine the time period.

At block 230, parameters of the reduced members may be determined. Parameters may include items such as spend growth, transaction growth, growth in digital channels, growth in various merchant categories, etc. Both month over month (MoM) and quarter over quarter (QoQ) growths may be assessed to create a training dataset for the model. Apart from transaction level data, some customer attributes and demographics may be included such as millennial status, affluence status and card features such as portfolio name, rewards type, tenure of card.

By analyzing the data, other unexpected attributes may be determined. For example, it may be determined that a user may have a flight risk if the user is recently married or is recently had children. The relationship between recently married or recently having children may not be expected but may be revealed by analyzing the data of past consumers that have stopped using an account. Again, machine learning as described in FIGS. 3, 4a and 4b may be used to help discover the unexpected attributes.

At block 240, a flight risk for electronic payment users may be determined. The determination may include analyzing the attributes of the subset. An algorithm may be used to make the determination. In some embodiments, some of the attributes may have more importance than others. At a high level, the mere existence of some parameters may be indicative that a flight risk is likely. By reviewing the parameters, the flight risk may be determined. Again, machine learning as described in FIGS. 3, 4a and 4b may be used to help discover the flight risk.

At block 250, a flight risk score may be determined by scoring the parameters. Some parameters may have a higher likelihood of indicating a flight risk than other parameters. By scoring the parameters, an estimation of the likelihood of a flight risk may be determined. For example, a first parameter may indicate a 90% likelihood that a user is a flight risk while a second parameter may indicate a 60% likelihood that the user is a flight risk.

Further, the combination of parameters also may be analyzed to determine if a first combination has a given likelihood of a flight risk and a second combination may have a different given likelihood of a flight risk. For example, if spending on a first account has decreased and spending on a second account has increased, the combination may provide a high likelihood that a user may be a flight risk.

Scoring the parameters may include reviewing past electronic purchases of electronic account holders and selecting parameter of members that have reduced electronic account usage in the past. If the parameter is correlated with a high likelihood of an account becoming dormant, the parameter may be given a larger weight. Similarly, if a parameter is correlated with a low likelihood of an account becoming dormant, the parameter may be given a lower weight. Similarly, combinations of parameters may be reviewed to determine whether the parameters together may be determined to have a large weight or a low weight on whether an account may become dormant. Again, machine learning as described in FIGS. 3, 4a and 4b may be used to help score the parameters more accurately.

At block 260, flight risk members may be determined where flight risk members comprise members scored over a threshold. The threshold may be determined in a variety of ways. In one embodiment, the account issuer may be very aggressive and may want to know when the predicted dormancy is over 30 percent (the threshold would be 30 percent). In another embodiment, the account issue may be more picky and may want to know when the predicted dormancy is over 70 percent (the threshold would be 70 percent).

In some additional embodiments, the cost to keep the accounts likely to become dormant may be compared to cost if the accounts did go dormant. For example, if the initial aggressive offer on an account is extended, the aggressive offer may have a cost. Similarly, having an account go dormant may result in less revenue which may also have a cost. Thus the threshold may be optimized according to the desires of the account issuer.

At block 270, an electronic offer may be communicated to the flight risk members. In some situations, every flight risk may receive an offer. In other situations, only accounts over a threshold may receive an offer. The decision whether to make an offer may be determined in a variety of ways.

In one embodiment, past electronic offers to the flight risk members may be analyzed. A score for past electronic offers may be created where past electronic offers to the flight risk members may be scored based on a criteria. The score may be based on the success of the flight risk member not fleeing. In other embodiments, the score may also take into account the cost to keep the flight risk from fleeing. A criteria may be defined by the account issuer to determine the score.

As an example, a user that does the bare minimum to meet the criteria for a reward for an account may not be as desirable as a user that consistently and repeatedly exceeds the criteria to earn a reward. As another example, a user that has used an account consistently for years may be more desirable than a user that jumps from offer to offer, using an account for a couple months and then changing to another account that has a short term offer. Logically, the revenue from each of the above desired users may be determined and the revenue may be a factor to be considered in determining whether an offer to retain the user mays business sense.

A preferred electronic offer may be selected by selecting a past electronic offer with a highest score based on the criteria defined by the account issuer. The criteria may be defined in a variety of ways. In some embodiments, the criteria may simply be the offer with the best retention rate. In other embodiments, the criteria may take into account the cost of the offer and the retention rate. In yet another embodiment, the offer make take into account the revenue retained in view of the cost of the offer and in view of the success rate. Of course, other criteria are possible and are contemplated. The preferred electronic offer may then be communicated to the flight risk members. Logically, the results of the offer may be tracked such that the offers may continue to improve in the future.

In some embodiments, machine learning may be used to adjust the weights over time such that past weights may be analyzed in view of the results of retaining the desired account users to better determine the most appropriate weights in the future. In some embodiments, the weighting may be refined over time. Machine learning may be used to analyze past weights in view of the actual results of users or entities being retained. While the present disclosure may be embodied in many different forms, the drawings and discussion are presented with the understanding that the present disclosure is an exemplification and is not intended to be limited to any one of the embodiments illustrated.

The present disclosure provides a solution to the long-felt need described above. In particular, the system and the methods described herein may be configured to efficiently provide efficient determination of current credit worthiness based on courses and certifications. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

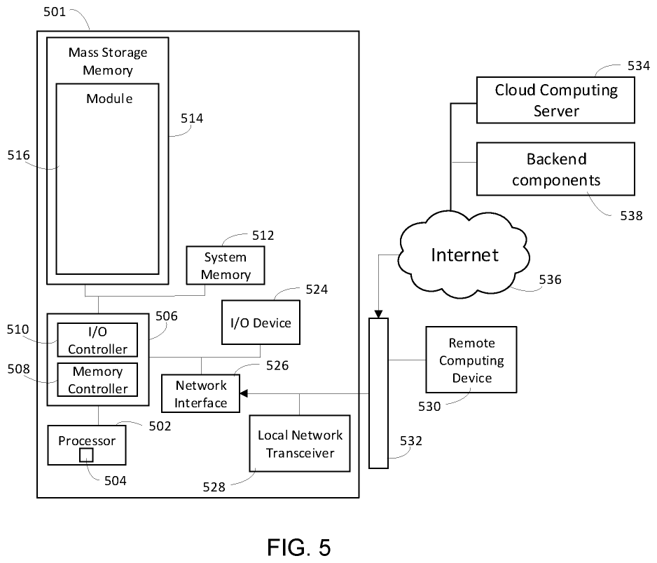

As noted, many computers may be used by the system. FIG. 5 may illustrate a sample computing device 501. The computing device 501 includes a processor 502 that is coupled to an interconnection bus. The processor 502 includes a register set or register space 504, which is depicted in FIG. 5 as being entirely on-chip, but which could alternatively be located entirely or partially off-chip and directly coupled to the processor 502 via dedicated electrical connections and/or via the interconnection bus. The processor 502 may be any suitable processor, processing unit or microprocessor. Although not shown in FIG. 5, the computing device 501 may be a multi-processor device and, thus, may include one or more additional processors that are identical or similar to the processor 502 and that are communicatively coupled to the interconnection bus.

The processor 502 of FIG. 5 is coupled to a chipset 506, which includes a memory controller 508 and a peripheral input/output (I/O) controller 510. As is well known, a chipset typically provides I/O and memory management functions as well as a plurality of general purpose and/or special purpose registers, timers, etc. that are accessible or used by one or more processors coupled to the chipset 506. The memory controller 508 performs functions that enable the processor 502 (or processors if there are multiple processors) to access a system memory 512 and a mass storage memory 514, that may include either or both of an in-memory cache (e.g., a cache within the memory 512) or an on-disk cache (e.g., a cache within the mass storage memory 514).

The system memory 512 may include any desired type of volatile and/or non-volatile memory such as, for example, static random access memory (SRAM), dynamic random access memory (DRAM), flash memory, read-only memory (ROM), etc. The mass storage memory 514 may include any desired type of mass storage device. For example, the computing device 501 may be used to implement a module 516 (e.g., the various modules as herein described). The mass storage memory 514 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 501, the systems and methods described herein. Thus, a module, block, function, operation, procedure, routine, step, and method can be implemented in hardware, firmware, and/or software. In one embodiment, program modules and routines are stored in mass storage memory 514, loaded into system memory 512, and executed by a processor 502 or can be provided from computer program products that are stored in tangible computer-readable storage mediums (e.g. RAM, hard disk, optical/magnetic media, etc.).

The peripheral I/O controller 510 performs functions that enable the processor 502 to communicate with a peripheral input/output (I/O) device 524, a network interface 526, a local network transceiver 528, (via the network interface 526) via a peripheral I/O bus. The I/O device 524 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 524 may be used with the module 516, etc., to receive data from the transceiver 528, send the data to the components of the system 100, and perform any operations related to the methods as described herein. The local network transceiver 528 may include support for a Wi-Fi network, Bluetooth, Infrared, cellular, or other wireless data transmission protocols. In other embodiments, one element may simultaneously support each of the various wireless protocols employed by the computing device 501. For example, a software-defined radio may be able to support multiple protocols via downloadable instructions. In operation, the computing device 501 may be able to periodically poll for visible wireless network transmitters (both cellular and local network) on a periodic basis. Such polling may be possible even while normal wireless traffic is being supported on the computing device 501. The network interface 526 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 508 and the I/O controller 510 are depicted in FIG. 5 as separate functional blocks within the chipset 506, the functions performed by these blocks may be integrated within a single integrated circuit or may be implemented using two or more separate integrated circuits. The computing environment 500 may also implement the module 516 on a remote computing device 530. The remote computing device 530 may communicate with the computing device 501 over an Ethernet link 532. In some embodiments, the module 516 may be retrieved by the computing device 501 from a cloud computing server 534 via the Internet 536. When using the cloud computing server 534, the retrieved module 516 may be programmatically linked with the computing device 501. The module 516 may be a collection of various software platforms including artificial intelligence software and document creation software or may also be a Java® applet executing within a Java® Virtual Machine (JVM) environment resident in the computing device 501 or the remote computing device 530. The module 516 may also be a “plug-in” adapted to execute in a web-browser located on the computing devices 501 and 530. In some embodiments, the module 516 may communicate with back end components 538 via the Internet 536.

The system 500 may include but is not limited to any combination of a LAN, a MAN, a WAN, a mobile, a wired or wireless network, a private network, or a virtual private network. It is understood that any number of client computers are supported and can be in communication within the system 500.

Additionally, certain embodiments are described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a processor configured using software, the processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of determining changes in electronic payment accounts comprising:
determining a subset of electronic account holders wherein the subset used an electronic account to make a purchase in predetermined categories;
analyzing purchase habits of the subset comprising;
reviewing past purchase of the subset during a time period;
determining reduced members of the subset wherein reduced members comprise members which reduce usage of the electronic account during the time period;
determining parameters of the reduced members;
determining flight risk for electronic payment users comprising:
analyzing the subset for members that comprise the parameters;
determining a flight risk score for electronic payment users in the subset by scoring the parameters for the electronic payment users in the subset wherein the flight risk score comprises an indication of the probability that an electronic account holder will switch from a first electronic account to a second electronic account with a new personalized offer;
identifying flight risk members of the subset wherein flight risk members comprise subset members with a flight risk score over a threshold; and
communicating an electronic offer to the flight risk members.

2. The method of claim 1, wherein predetermined categories are determined by reviewing past electronic purchases of electronic account holders and selecting account holders that changed behavior is measurable ways.

3. The method of claim 1, wherein analyzing the purchase habits of the subset comprises reviewing past electronic purchases using an algorithm to identify parameters.

4. The method of claim 3, further comprising testing a plurality of algorithms and selecting the algorithm that performs best.

5. The method of claim 1, wherein scoring the parameters comprises reviewing past electronic purchases of electronic account holders and selecting parameters of members that have reduced electronic account usage in the past.

6. The method of claim 1, further comprising:
analyzing past electronic offers to the flight risk members;
creating a score for past electronic offers comprising scoring past electronic offers to the flight risk members based on a criteria;
selecting a preferred electronic offer comprising selecting the past electronic offer with a highest score; and
communicating the preferred electronic offer to the flight risk members.

7. The method of claim 1, wherein the flight risk member comprise members that reduce usage of one electronic payment device in favor of an additional electronic payment device.

8. A computer system for determining changes in electronic payment accounts comprising a processor, a memory and an input/output circuit, the processor being physically configured for:
determining a subset of electronic account holders wherein the subset used an electronic account to make a purchase in predetermined categories;
analyzing purchase habits of the subset comprising;
reviewing past purchase of the subset during a time period;
determining reduced members of the subset wherein reduced members comprise members which reduce usage of the electronic account during the time period;
determining parameters of the reduced members;
determining flight risk for electronic payment users comprising:
analyzing the subset for members that comprise the parameters;
determining a flight risk score for electronic payment users in the subset by scoring the parameters for the electronic payment users in the subset wherein the flight risk score comprises an indication of the probability that an electronic account holder will switch from a first electronic account to a second electronic account with a new personalized offer;
identifying flight risk members of the subset wherein flight risk members comprise subset members with a flight risk score over a threshold; and
communicating an electronic offer to the flight risk members.

9. The computer system of claim 8, wherein predetermined categories are determined by reviewing past electronic purchases of electronic account holders and selecting account holders that changed behavior is measurable ways.

10. The computer system of claim 8, wherein analyzing the purchase habits of the subset comprises reviewing past electronic purchases using an algorithm to identify parameters.

11. The computer system of claim 10, further comprising the processor being physically configured for testing a plurality of algorithms and selecting the algorithm that performs best.

12. The computer system of claim 8, wherein scoring the parameters comprises the processor being physically configured for reviewing past electronic purchases of electronic account holders and selecting parameter of members that have reduced electronic account usage in the past.

13. The computer system of claim 8, further comprising the processor being physically configured for:
analyzing past electronic offers to the flight risk members;
creating a score for past electronic offers comprising scoring past electronic offers to the flight risk members based on a criteria;
selecting a preferred electronic offer comprising selecting the past electronic offer with the highest score; and
communicating the preferred electronic offer to the flight risk members.

14. The computer system of claim 8, wherein the flight risk member comprise members that reduce usage of one electronic payment device in favor of an additional electronic payment device.

15. A tangible computer readable medium physically configured according to computer executable instructions, the instruction comprising computer executable instructions for:
determining a subset of electronic account holders wherein the subset used an electronic account to make a purchase in predetermined categories;
analyzing purchase habits of the subset comprising;
reviewing past purchase of the subset during a time period;
determining reduced members of the subset wherein reduced members comprise members which reduce usage of the electronic account during the time period;
determining parameters of the reduced members;
determining flight risk for electronic payment users comprising:
analyzing the subset for members that comprise the parameters;
determining a flight risk score for electronic payment users in the subset by scoring the parameters for the electronic payment users in the subset wherein the flight risk score comprises an indication of the probability that an electronic account holder will switch from a first electronic account to a second electronic account with a new personalized offer;
identifying flight risk members of the subset wherein flight risk members comprise subset members with a flight risk score over a threshold; and
communicating an electronic offer to the flight risk members.

16. The tangible computer readable medium of claim 15, wherein predetermined categories are determined by reviewing past electronic purchases of electronic account holders and selecting account holders that changed behavior is measurable ways.

17. The tangible computer readable medium of claim 15, wherein analyzing the purchase habits of the subset comprises reviewing past electronic purchases using an algorithm to identify parameters.

18. The tangible computer readable medium of claim 15, wherein scoring the parameters comprises reviewing past electronic purchases of electronic account holders and selecting parameters of members that have reduced electronic account usage in the past.

19. The tangible computer readable medium of claim 15, further comprising computer executable instruction for:
analyzing past electronic offers to the flight risk members;
creating a score for past electronic offers comprising scoring past electronic offers to the flight risk members based on a criteria;
selecting a preferred electronic offer comprising selecting the past electronic offer with the highest score; and
communicating the preferred electronic offer to the flight risk members.

20. The tangible computer readable medium of claim 15, wherein the flight risk member comprise members that reduce usage of one electronic payment device in favor of an additional electronic payment device.
